(19) United States
(12) Patent Application Publication
(10) Pub. No.: US 2026/0025804 A1
(43) Pub. Date: Jan. 22, 2026

(54) MULTI-SLOT SCHEDULING IN CONTEXT OF SBFD

(71) Applicant: Nokia Technologies Oy, Espoo (FI)

(72) Inventors: Jie GAO, Hangzhou (CN); Youngsoo YUK, Seoul (KR); Nhat-Quang NHAN, Massy (FR); Jing Yuan SUN, Beijing (CN)

(21) Appl. No.: 19/119,167

(22) PCT Filed: Nov. 2, 2022
(86) PCT No.: PCT/CN2022/129341

§ 371 Date: Apr. 8, 2025

(51) Int. Cl. H04W 72/0453; H04L 5/14; H04W 72/231

(52) U.S. Cl. CPC H04W 72/0453; H04L 5/14; H04W 72/231

(57) ABSTRACT

Example embodiments of the present disclosure relate to a terminal device, a network device, methods, apparatuses and a computer readable storage medium for multi-slot scheduling in the context of SBFD. A terminal device receives a DCI from a network device, where the DCI comprises at least one FDRA field for at least one communication to be dynamically scheduled or be activated. The terminal device determines different FDRAs for an SBFD communication and a non-SBFD communication based on the at least one FDRA field in the DCI. As such, the terminal device may perform communications based on the different FDRAs. Thus, the larger bandwidth in the non-SBFD time units can be exploited, the reliability of the multi-slot scheduling can be improved, and the efficiency of the resources may be higher.

### FIELD

Example embodiments of the present disclosure generally relate to the field of telecommunication and in particular, to a terminal device, a network device, methods, apparatuses and a computer readable storage medium for a solution of multi-slot scheduling in context of subband non-overlapping full duplex (SBFD).

### BACKGROUND

Recently the third generation partnership project (3GPP) has agreed to initiate a study item on SBFD. SBFD allows simultaneous downlink (DL) and uplink (UL) transmissions on different physical resource blocks (PRBs) or subbands within an unpaired wideband new radio (NR) cell.

Multiple UL or DL transmissions can be scheduled in multiple slots, which can be referred to as multi-slot scheduling. In the technique of multi-slot scheduling, multiple transmissions may have a same frequency domain resource allocation. In case the multi-slot scheduling is performed in the context of SBFD, the same frequency domain resource allocation may result in an insufficient usage of the frequency resources, and thus the communication efficiency is low.

### SUMMARY

In general, example embodiments of the present disclosure provide a solution for multi-slot scheduling in context of SBFD.

In a first aspect, there is provided a terminal device. The terminal device comprises at least one processor and at least one memory storing instructions that, when executed by the at least one processor, cause the terminal device at least to: receive downlink control information (DCI) from a network device, the DCI comprising at least one frequency-domain resource allocation (FDRA) field for at least one communication to be dynamically scheduled or be activated; determine a first frequency domain resource allocation (FDRA) on a first bandwidth of a first communication and a second FDRA on a second bandwidth of a second communication, based on the at least one FDRA field in the DCI; and perform the first communication and the second communication with the network device based on the first FDRA and the second FDRA, respectively, where the first communication is one of the SBFD communication or the non-SBFD communication, and the second communication is another one of the SBFD communication or the non-SBFD communication.

In a second aspect, there is provided a network device. The network device comprises at least one processor and at least one memory storing instructions that, when executed by the at least one processor, cause the network device at least to: transmit downlink control information (DCI) to a terminal device, the DCI comprising at least one frequency domain resource allocation (FDRA) field for at least one communication to be dynamically scheduled or be activated, the at least one FDRA in the DCI being for determining a first FDRA on a first bandwidth of a first communication and a second FDRA on a second bandwidth of a second communication; and perform the first communication and the second communication with the terminal device based on the first FDRA and the second FDRA, respectively, where the first communication is one of the SBFD communication or the non-SBFD communication, and the second communication is another one of the SBFD communication or the non-SBFD communication.

In a third aspect, there is provided a method performed by a terminal device. The method comprises: receiving, at a terminal device from a network device, downlink control information (DCI) comprising at least one frequency-domain resource allocation (FDRA) field for at least one communication to be dynamically scheduled or be activated; determining a first FDRA on a first bandwidth of a first communication and a second FDRA on a second bandwidth of a second communication based on the at least one FDRA field in the DCI; and performing the first communication and the second communication with the network device based on the first FDRA and the second FDRA, respectively, where the first communication is one of the SBFD communication or the non-SBFD communication, and the second communication is another one of the SBFD communication or the non-SBFD communication.

In a fourth aspect, there is provided a method performed by a network device. The method comprises: transmitting, at a network device to a terminal device, downlink control information (DCI), the DCI comprising at least one frequency-domain resource allocation (FDRA) field for at least one communication to be dynamically scheduled or be activated, the at least one FDRA field in the DCI being for determining a first FDRA on a first bandwidth of a first communication and a second FDRA on a second bandwidth of a second communication; and performing the first communication and the second communication with the terminal device based on the first FDRA and the second FDRA, respectively, where the first communication is one of the SBFD communication or the non-SBFD communication, and the second communication is another one of the SBFD communication or the non-SBFD communication.

In a fifth aspect, there is provided an apparatus. The apparatus comprises: means for receiving, at a terminal device from a network device, downlink control information (DCI) comprising at least one frequency-domain resource allocation (FDRA) field for at least one communication to be dynamically scheduled or be activated; means for determining a first FDRA on a first bandwidth of a first communication and a second FDRA on a second bandwidth of a second communication based on the at least one FDRA field in the DCI; and means for performing the first communication and the second communication with the network device based on the first FDRA and the second FDRA, respectively, where the first communication is one of the SBFD communication or the non-SBFD communication, and the second communication is another one of the SBFD communication or the non-SBFD communication.

In a sixth aspect, there is provided an apparatus. The apparatus comprises: means for transmitting, at a network device to a terminal device, downlink control information (DCI) comprising at least one frequency domain resource allocation (FDRA) field for at least one communication to be dynamically scheduled or be activated, the at least one FDRA in the DCI being for determining a first FDRA on a first bandwidth of a first communication and a second FDRA on a second bandwidth of a second communication; and means for performing the first communication and the second communication with the terminal device based on the first FDRA and the second FDRA, respectively, where the first communication is one of the SBFD communication or the non-SBFD communication, and the second communication is another one of the SBFD communication or the non-SBFD communication.

In a seventh aspect, there is provided a non-transitory computer readable medium comprising program instructions for causing an apparatus to perform at least the method in the third or fourth aspect.

In an eighth aspect, there is provided a computer program comprising instructions, which, when executed by an apparatus, cause the apparatus at least to perform the method in the third or fourth aspect.

In a ninth aspect, there is provided a terminal device. The terminal device comprises: receiving circuitry configured to receive, from a network device, downlink control information (DCI) comprising at least one frequency-domain resource allocation (FDRA) field for at least one communication to be dynamically scheduled or be activated; determining circuitry configured to determine a first FDRA on a first bandwidth of a first communication and a second FDRA on a second bandwidth of a second communication based on the at least one FDRA field in the DCI; and performing circuitry configured to perform the first communication and the second communication with the network device based on the first FDRA and the second FDRA, respectively, where the first communication is one of the SBFD communication or the non-SBFD communication, and the second communication is another one of the SBFD communication or the non-SBFD communication.

In a tenth aspect, there is provided a network device. The network device comprises: transmitting circuitry configured to transmit, to a terminal device. downlink control information (DCI), the DCI comprising at least one frequency-domain resource allocation (FDRA) field for at least one communication to be dynamically scheduled or be activated, the at least one FDRA field in the DCI being for determining a first FDRA on a first bandwidth of a first communication and a second FDRA on a second bandwidth of a second communication; and performing circuitry configured to perform the first communication and the second communication with the terminal device based on the first FDRA and the second FDRA, respectively, where the first communication is one of the SBFD communication or the non-SBFD communication, and the second communication is another one of the SBFD communication or the non-SBFD communication.

In an eleventh aspect, there is provided a computer readable medium comprising program instructions that, when executed by an apparatus, cause the apparatus to perform at least the method in the third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIGS. 1A-1C illustrate schematic diagrams of FDD, TDD, and FDU respectively;

FIGS. 2A-2B illustrate schematic diagrams of co-channel interference types in SBFD deployment;

FIG. 3A illustrate a schematic diagram of an example of RA type 0 of FDRA for PUSCH;

FIG. 3B illustrate a schematic diagram of an example of RA type 1 of FDRA for PUSCH;

FIG. 4 illustrates an example diagram of SBFD slots and non-SBFD slots;

FIG. 5 illustrates an example of a network environment in which some example embodiments of the present disclosure may be implemented;

FIG. 6 illustrates an example of a process flow in accordance with some example embodiments of the present disclosure;

FIG. 7 illustrates a flowchart of a method implemented at a terminal device in accordance with some example embodiments of the present disclosure;

FIG. 8 illustrates a flowchart of a method implemented at a network device in accordance with some example embodiments of the present disclosure;

FIG. 9 illustrates a simplified block diagram of a device that is suitable for implementing some example embodiments of the present disclosure; and

FIG. 10 illustrates a block diagram of an example of a computer readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic. but it is not necessary that every embodiment includes the particular feature, structure, or characteristic. Moreover, such phrases are not necessarily referring to the same embodiment. Further, when a particular feature, structure, or characteristic is described in connection with an embodiment. it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well. unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), New Radio (NR), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G). the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) NB (also referred to as a gNB), a Remote Radio Unit (RRU), a radio header (RH), a remote radio head (RRH), an integrated access and backhaul (IAB) node, a relay, a low power node such as a femto, a pico, and so forth, depending on the applied terminology and technology.

The term “terminal device” refers to any end device that may be capable of wireless communication. By way of example rather than limitation, a terminal device may also be referred to adapt as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a machine type communication (MTC) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

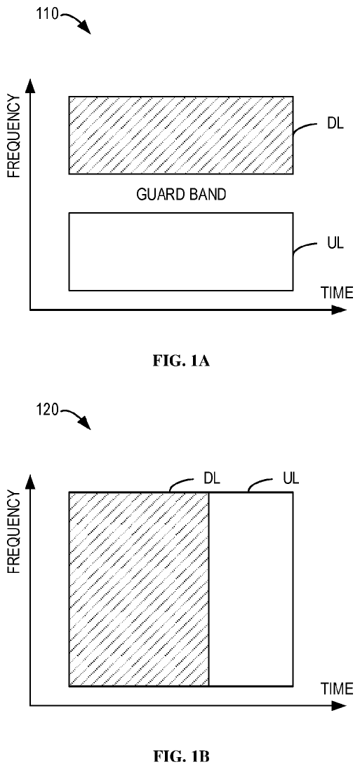

3GPP 5G NR currently supports two duplexing modes: frequency division duplex (FDD) for paired bands and time division duplex (TDD) for unpaired bands. FIGS. 1A-1B illustrate schematic diagrams of FDD and TDD respectively. In TDD, the time domain resource is split between downlink and uplink, and a limited time duration is allocated for the uplink in TDD, which would result in reduced coverage, increased latency, and reduced capacity.

Motivated by this, 3GPP has agreed to initiate a release 18 (R18) study item on the evolution of duplexing operation in NR that addresses the challenges above. One of the objectives of the study item is to allow simultaneous DL and UL transmission on different physical resource blocks (PRBs)/subbands within an unpaired wideband NR cell, which may be called as a subband non-overlapping full duplex (SBFD).

In the context of the present disclosure, the duplexing scheme of SBFD may also be referred to as a cross-division duplexing (xDD) scheme or a Flexible Duplexing (FDU) scheme. FIG. 1C illustrates schematic diagram 130 of FDU.

The following text box describes some non-restrictive objectives of the R18 study item related to SBFD. However, it is noted that example embodiments of the present disclosure are not limited to the objectives shown in the text box.

In this study item, the followings are assumed:
Duplex enhancement at the gNB side
Half duplex operation at the UE side
No restriction on frequency ranges
The detailed objectives are as follows:
(. . .)
Study the subband non-overlapping full duplex and potential
enhancements on dynamic/flexible TDD (RAN1, RAN4).
Identify possible schemes and evaluate their feasibility and performances
(RAN1).
Study inter-gNB and inter-UE CLI handling and identify solutions to
manage them (RAN1).
Consider intra-subband CLI and inter-subband CLI in case of the
subband non-overlapping full duplex.
Study the performance of the identified schemes as well as the impact on
legacy operation assuming their co-existence in co-channel and adjacent
channels (RAN1).
Study the feasibility of and impact on RF requirements considering
adjacent-channel co-existence with the legacy operation (RAN4).
Study the feasibility of and impact on RF requirements considering the
self-interference, the inter-subband CLI, and the inter-operator CLI at
gNB and the inter-subband CLI and inter-operator CLI at UE (RAN4).
(. . .)

SBFD may introduce at least one cross-link interference (CLI) type, which may be named as co-channel inter-subband CLI. This interference can be better classified as: (1) gNB self-interference; (2) intra-cell UE-to-UE co-channel inter-subband CLI; (3) inter-cell UE-to-UE co-channel inter-subband CLI; and (4) gNB-to-gNB co-channel inter-subhand CLI.

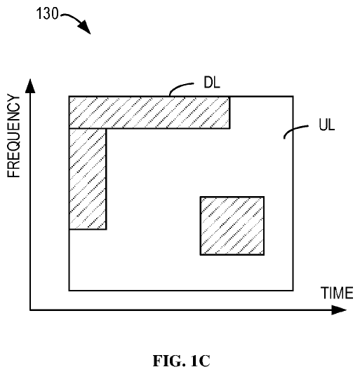

FIG. 2A illustrates a schematic diagram 210 of co-channel interference types in SBFD deployment. It is assumed that the gNB 201 and the gNB 202 are in the same frequency domain partitioning, UE 203 and UE 204 are within a cell of gNB 201, and UE 205 and UE 206 are within a cell of gNB 202. There may be a gNB self-interference 212, an intra-cell UE-to-UE co-channel inter-subband CLI 214, an inter-cell UE-to-UE co-channel inter-subband CLI 216, or a gNB-to-gNB co-channel inter-subband CLI 218.

Besides these new CLI types (1)-(4), in case of different frequency domain partitioning in neighbor cells, the system may also suffer from co-channel intra-subband CLI, i.e., CLI from transmissions on overlapping frequency resources: (5) gNB-to-gNB inter-cell co-channel intra-subband CLI; and (6) UE-to-UE inter-cell co-channel intra-subband CLI.

FIG. 2B illustrates another schematic diagram 220 of co-channel interference types in SBFD deployment. It is assumed that the gNB 207 and the gNB 208 are in different frequency domain partitioning. UE 209 is within a cell of gNB 207, and UE 219 is within a cell of gNB 208. There may be a gNB-to-gNB inter-cell co-channel intra-subband CLI 222, or a UE-to-UE inter-cell co-channel intra-subband CLI 224.

There are mainly two types of frequency domain resource assignment (FDRA) for physical uplink shared channel (PUSCH) in 5G NR, namely, resource allocation (RA) type 0 and RA type 1. The network device (such as gNB) configures either type 0 or type 1, or both type 0 and type 1, and indicates RA type to be used for a scheduled PUSCH transmission by the scheduling DCI.

In uplink RA type 0, the resource block assignment information in the scheduling DCI includes a bitmap indicating the Resource Block Groups (RBGs) that are allocated to the scheduled UE, where a RBG is a set of consecutive resource blocks defined by higher layer parameter rbg-Size configured in pusch-Config and the size of the bandwidth part (BWP). Table 1 illustrates two possible configurations of rbg-Size for each range of BWP size. It is understood that RA type 0 may support indicating non-contiguous PRBs by using a bitmap.

TABLE 1

RBG size (P)

| Bandwidth part size | Configuration 1 | Configuration 2 |
|---|---|---|
| 1~36 | 2 | 4 |
| 37~72 | 4 | 8 |
| 73~144 | 8 | 16 |
| 145~275 | 16 | 16 |

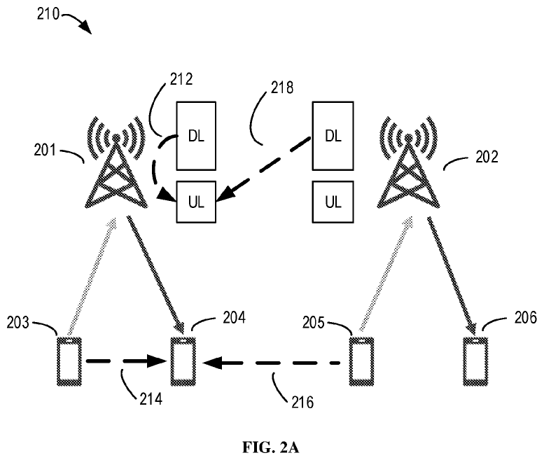

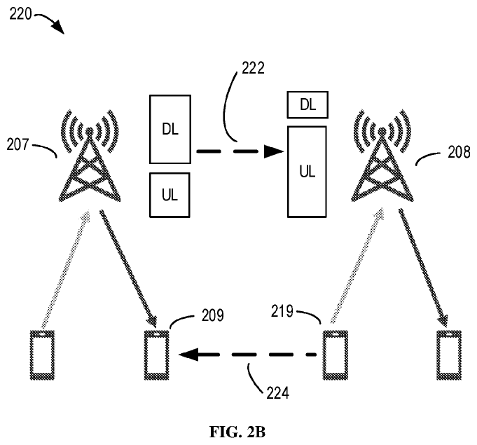

FIG. 3A illustrates a schematic diagram 310 of an example of RA type 0 of FDRA for PUSCH. It is assumed that BWP size 312 equals to 20 RBs, and RBG size equals to 4 RBs. The bitmap 314 included in the scheduling DCI may be “11001” in the example shown in FIG. 3A.

RA type 1 indicates FDRA via a starting resource block (may represented by RBₛₜₐᵣₜ) and a length in terms of contiguously allocated resource blocks (may represented by L_{RBs}). FIG. 3B illustrates a schematic diagram 320 of an example of RA type 0 of FDRA for PUSCH. As show in FIG. 3B, the BWP size 322 equals to 20 RBs, and RBₛₜₐᵣₜ 324 and L_{RBs} (equals to 10 RBs) 326 can be used to indicate the FDRA.

It is understood that RA type 1 may reduce DCI overhead by avoiding using a bitmap. The resource block assignment information in the scheduling DCI indicates to a scheduled UE a set of contiguously allocated non-interleaved resource blocks within the active BWP of size (N_{BWP}^{size}), except for the case when DCI format 0_0 is decoded in any common search space in which case the size of the initial UL bandwidth part N_{BWP,0}^{size} shall be used.

An uplink type 1 resource allocation field includes a resource indication value (RIV) corresponding to a RBₛₜₐᵣₜ and a L_{RBs}. Based on RBₛₜₐᵣₜ and L_{RBs}, RIV is given by:

$$if ( {L}_{RBs} - 1 ) \leq ⌊ {N}_{BWP}^{size} / 2 ⌋ , \\ then \\ RIV = {N}_{BWP}^{size} ( {L}_{RBs} - 1 ) + {RB}_{start} ; \\ Else \qquad ( 1 )$$

$$RIV = {N}_{BWP}^{size} ( {N}_{BWP}^{size} - {L}_{RBs} + 1 ) + ( {N}_{BWP}^{size} - 1 - {RB}_{start} ) , \qquad ( 2 )$$

where L_{RBs}≥1 and shall not exceed

$${N}_{BWP}^{size} - {RB}_{start} .$$

It is to be noted that FIGS. 3A-3B are illustrated for a FDRA procedure for PUSCH, however similar FDRA procedure is applicable for physical downlink shared channel (PDSCH) and the present disclosure will not repeat herein.

Several techniques that allow scheduling multiple UL or DL transmissions in multiple slots with a single scheduling DCI have been specified and improved in the previous releases of 3GPP specifications.

For example, there exist two techniques that allow scheduling multiple UL transmissions in multiple slots using a single DCI, which are referred to as PUSCH repetitions and multi-PUSCH scheduling. These techniques have the following common design aspects:
The single DCI schedules multiple PUSCHs, each PUSCH is within a slot; and
The scheduled PUSCHs have the same frequency domain resource allocation (i.e., the same number of physical resource blocks (PRBs) and the same location of these PRBs in frequency domain), which is indicated by the single DCI.

However, these techniques have the following different design aspects:

For PUSCH repetitions, only a single starting and length of a PUSCH within a slot is indicated by the scheduling DCI, i.e., a single start and length indicator value (SLIV). This single SLIV is used by the UE for determining the time domain resource for the scheduled PUSCH in each slot, depending on the PUSCH repetition type: (1) For PUSCH repetition type A (introduced/enhanced in Rel-15/16): The same start and length indicated by the single SLIV is applied across all scheduled PUSCHs. (2) For PUSCH repetition type B (introduced in Rel-16): The single SLIV is used for determining multiple back-to-back nominal repetitions with the same length and each nominal repetition can span across the slot boundary. Then, each nominal repetition is split into multiple actual repetitions if it crosses the slots boundary or invalid symbols. All the PUSCH repetitions are used for transmitting a single transport block using different redundancy versions and the same hybrid automatic repeat request (HARQ) process number.

For multi-PUSCH scheduling (introduced/enhanced in Rel-16/17), multiple SLIVs can be indicated by the scheduling DCI, each valid SLIV corresponds to one PUSCH from the multiple scheduled PUSCHs. The scheduled PUSCHs are used for transmitting different transport blocks with different HARQ process numbers.

Similarly, there are PDSCH repetition and multi-PDSCH scheduling for downlink transmissions. PDSCH repetition is supported in 5G NR (introduced in Rel-15) with similar mechanism as described for PUSCH repetition type A. Multi-PDSCH scheduling is supported in 5G NR (introduced in Rel-17) with similar mechanism as described for multi-PUSCH scheduling.

Aside from PUSCH/PDSCH repetitions scheduled by a DCI (referred to as dynamic grant (DG)), there exist also frameworks for transmitting the repetitions without a scheduling DCI, which is referred to as semi-persistent scheduling (SPS) for PDSCH or configured grant (CG) for PUSCH. The idea from SPS/CG scheduling is that the transmission occasions are preconfigured via RRC, and the gNB/UE can transmit data in these occasions without transmitting/waiting for a DCI. There are also two type of CG PUSCH, where Type 1 CG PUSCH does not require an activation DCI while Type 2 CG PUSCH requires a DCI for activating the usage of the transmission occasions. For Type 1 CG PUSCH, time and frequency resources of the transmission occasions are indicated via RRC configuration. For Type 2 CG PUSCH, time and frequency resources of the transmission occasions are indicated via the activation DCI.

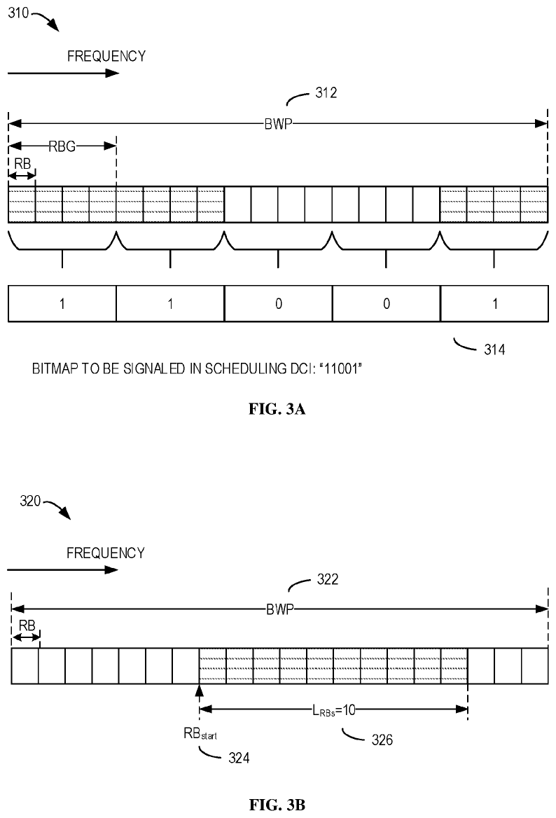

Based on the description of SBFD operation shown in FIG. 1C, it can be observed that there are two slots types exist for both DL and UL transmissions: SBFD slots and non-SBFD slots. FIG. 4 illustrates an example diagram 400 of SBFD slots and non-SBFD slots. As shown in FIG. 4, a DL transmission can be performed within non-SBFD slots 432 and SBFD slots 434, and a UL transmission can be performed within SBFD slots 434 and non-SBFD slots 436. In other words, the non-overlapping DL subbands and UL subband both exist during the SBFD slots 434, the entire band is used for DL transmission during the non-SBFD slots 432, and the entire band is used for UL transmission during the non-SBFD slots 436. In some examples, the non-SBFD slots 432 may also be called as legacy slots or full DL slots, and the non-SBFD slots 436 may also be called as legacy slots or full UL slots.

It is to be noted that SBFD slots and non-SBFD slots are illustrates are illustrated with reference to FIG. 4, however, the present disclosure is also applied for SBFD mini-slots and non-SBFD mini-slots, or SBFD symbols and non-SBFD symbols, or other time units not listed here.

In the context of the present disclosure, the term “SBFD-aware UE” may be used, and at least the operation mode with time and frequency locations of subbands for SBFD operation are known to the SBFD-aware UE. In the context of the present disclosure, the terms SBFD-aware, FDU-aware, SBFD-capable, FDU-capable, or the like may be used interchangeable.

Based on the description of multi-slot scheduling, the scheduled PUSCHs/PDSCHs have the same frequency domain resource allocation. In the context of SBFD, the same frequency domain resource allocation for the scheduled PUSCHs/PDSCHs may result in a low efficiency of the frequency domain resources and thus a further study is needed.

Example embodiments of the present disclosure provide a solution for multi-slot scheduling in the context of SBFD. Especially, a terminal device may receive a DCI from a network device, and determine different FDRAs for an SBFD communication and a non-SBFD communication. As such, the terminal device may perform communications based on the different FDRAs. Thus, the larger bandwidth in the non-SBFD time units can be exploited, the reliability of the multi-slot scheduling can be improved, and the efficiency of the resources may be higher. Principles and some example embodiments of the present disclosure will be described in detail below with reference to the accompanying drawings.

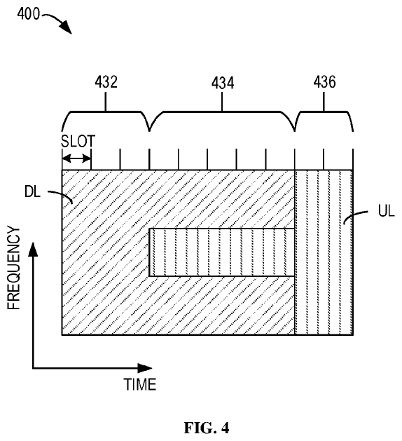

FIG. 5 illustrates an example of a network environment 500 in which some example embodiments of the present disclosure may be implemented. The environment 500, which may be a part of a communication network, comprises a terminal device 510 and a network device 520.

The communication environment 500 may comprise any suitable number of devices and cells. In the communication environment 500, the network device 520 can provide services to the terminal device 510, and the network device 520 and the terminal device 510 may communicate data and control information with each other. In some embodiments, the network device 520 and the terminal device 510 may communicate with direct links/channels.

In the system 500, a link from the network device 520 to the terminal device 510 is referred to as a downlink (DL), while a link from the terminal device 510 to the network device 520 is referred to as an uplink (UL). In downlink, the network device 520 is a transmitting (TX) device (or a transmitter) and the terminal device 510 is a receiving (RX) device (or a receiver). In uplink, the terminal device 510 is a transmitting TX device (or a transmitter) and the network device 520 is a RX device (or a receiver). It is to be understood that the network device 520 may provide one or more serving cells. In some embodiments, the network device 520 can provide multiple cells.

Communications in the network environment 500 may be implemented according to any proper communication protocol(s), comprising, but not limited to, cellular communication protocols of the first generation (1G), the second generation (2G), the third generation (3G), the fourth generation (4G), the fifth generation (5G) and the sixth generation (6G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA). Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the numbers of devices (i.e., the terminal device 510 and the network device 520) and their connection relationships and types shown in FIG. 5 are only for the purpose of illustration without suggesting any limitation. For example, the environment 500 may include any suitable numbers of devices adapted for implementing embodiments of the present disclosure. For example, while FIG. 5 depicts the terminal device 510 as a mobile phone, the terminal device 510 may be any type of user equipment.

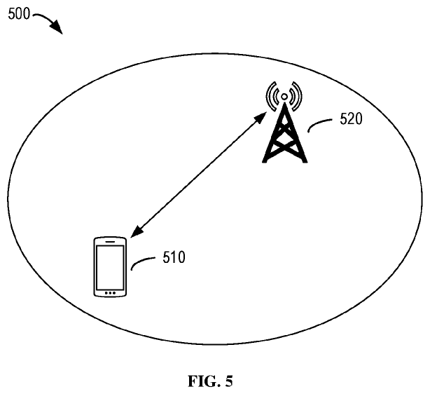

FIG. 6 illustrates an example of a process flow 600 in accordance with some example embodiments of the present disclosure. For the purpose of discussion, the process flow 600 will be described with reference to FIG. 5. The process flow 600 involves a terminal device 510 and a network device 520. It would be appreciated that although the process flow 300 has been described in the network environment 500 of FIG. 5, this process flow may be likewise applied to other communication scenarios.

In some example embodiments, alternatively, as shown in FIG. 6, the network deice 520 may transmit 610 configuration information 612 to the terminal device 510. In some examples, the configuration information is carried in an RRC message or RRC signalling.

In some embodiments, the configuration information 612 may indicate one or more of: a frequency band, a first number of time units for both uplink and downlink transmissions, a first location of the first number of time units in a radio frame, a second number of time units for uplink transmission, a second location of the second number of time units in the radio frame, a third number of time units for downlink transmission, a third location of the third number of time units in the radio frame, or a resource allocation type. In some examples, the time units may be any one of: slots, mini-slots, or symbols. In some examples, the configuration information 612 may indicate:
a frequency band,
a number of slots/mini-slots/symbols during which the frequency band is split into multiple subbands, and at least one subband is used for DL transmissions and at least another one subband is used for UL transmissions, i.e., the number of SBFD slots/mini-slots/symbols, and the locations of the number of SBFD slots/mini-slots/symbols in a radio frame,
a number of slots/mini-slots/symbols during which the entire frequency band is used for DL transmissions or UL transmissions, i.e., the number of non-SBFD slots/mini-slots/symbols, and the locations of the number of SBFD slots/mini-slots/symbols in a radio frame, and
a resource allocation type.

In some example embodiments, the resource allocation type may be one or more of: RA type 0 or RA type 1. In some example embodiments, the configuration information 612 may further indicate trigger information. The trigger information may be used for triggering the terminal device 510 to determine different FDRAs for the SBFD communication and the non-SBFD communication.

On the other side of communication, the terminal device 510 receives 614 the configuration information 612. In the present disclosure, it is assumed that the terminal device 510 is a SBFD-aware UE.

Additionally or alternatively, the network device 520 may transmit trigger information to the terminal device 510, accordingly the terminal device 510 may receive the trigger information. In some example embodiments, the trigger information and the configuration information 612 may be carried in a same RRC message or in different RRC messages. In some example embodiments, the trigger information may be carried in a DCI.

In some embodiments, the trigger information may be used for triggering the terminal device 510 to determine different FDRAs for the SBFD communication and the non-SBFD communication based on at least one FDRA filed (for example, a single FDRA field) in a DCI.

The network deice 520 transmits 620 a DCI 622 to the terminal device 510. In some embodiments, the DCI 622 includes at least one FDRA field for at least one communication to be dynamically scheduled or be activated.

In some example embodiments, at least two communications are dynamically scheduled or activated by the DCI 622, where the at least two communications include at least one SBFD communication and at least one non-SBFD communication. In some examples, the communications are dynamically scheduled or activated by a single DCI without introducing additional bits.

In some examples, the DCI 622 may indicate that a portion of the communications is scheduled or configured on SBFD time units, and another portion of the communications is scheduled or configured on non-SBFD time units. The time units could be slots, mini-slots, or symbols.

For example, the DCI 622 may indicate that a first communication is scheduled or configure on SBFD slots, and a second communication is scheduled or configured on non-SBFD slots. For another example, the DCI 622 may indicate that a first communication is scheduled or configured on non-SBFD slots, and a second communication is scheduled or configured on SBFD slots.

In some examples, for the terminal device 510. the first communication and the second communication may be transmissions to the network device 520; for the network device 520. the first transmission and the second transmission may be receptions from the terminal device 510. In some other examples, for the terminal device 510, the first communication and the second communication may be receptions from the network device 520; for the network device 520, the first transmission and the second transmission may be transmissions to the terminal device 510.

In some examples, the first communication and the second communication are PUSCH repetitions or multi-PUSCH scheduling. In some other examples, the first communication and the second communication are PDSCH repetition or multi-PDSCH scheduling. In some other examples, the first communication and the second communication may be Type 1 CG PUSCH transmissions, Type 2 CG PUSCH transmission, or DG PUSCH transmissions.

In some example embodiments, the number of communications which the DCI 622 scheduled or configured may equal to or be greater than 2, for ease of description, two communications (i.e., the first communication and the second communication) are described in the following disclosure.

In some example embodiments, the DCI 622 includes at least one FDRA filed, for example, the DCI 622 includes a single FDRA field. In some example embodiments, the at least one FDRA is associated with a first bandwidth of the first communication. In some examples, the type of the first communication (SBFD, or non-SBFD) may be predefined by be preconfigured by the network device 520.

Additionally or alternatively, the network device 520 may transmit an indication to the terminal device 510, where the indication may indicate the type of the first communication associated with the at least one FDRA in the DCI 622. Accordingly, the terminal device 510 may receive the indication and know the type of the first communication. In some examples, the indication may be carried in an RRC message. For example, the RRC message may be the same one which carries the configuration information 612, or may be a different one from that carries the configuration information 612.

For example, if the type of the first communication is an SBFD communication, in other words, the first communication is scheduled on SBFD slots (or mini-slots or symbols), then the at least one FDRA field is associated with the UL/DL subband bandwidth used for SBFD slots (or mini-slots or symbols). For another example, if the type of the first communication is a non-SBFD communication, in other words, the first communication is scheduled on non-SBFD slots (or mini-slots or symbols), then the at least one FDRA field is associated with the entire UL/DL wideband bandwidth used for non-SBFD slots (or mini-slots or symbols).

In some example embodiments, a rule may be specified to predefine that the at least one FDRA field in the DCI 622 is associated with the bandwidth of non-SBFD slots (or mini-slots or symbols), that is, the entire UL/DL wideband bandwidth used for non-SBFD slots (or mini-slots or symbols). In some other example embodiments, a rule may be specified to predefine that the at least one FDRA field in the DCI 622 is associated with the bandwidth of SBFD slots (or mini-slots or symbols), that is, the UL/DL subband bandwidth used for SBFD slots (or mini-slots or symbols).

On the other side of communication, the terminal device 510 receives 624 the DCI 622. Accordingly, the terminal device 510 may obtain the at least one FDRA filed (such as a single FDRA filed).

The terminal device 510 determines 640 a first FDRA and a second FDRA based on the DCI 622. Specifically, the terminal device 510 determine a first FDRA for a first communication on a first bandwidth and a second FDRA for a second communication on a second bandwidth based on the at least one FDRA field in the DCI 622.

In some example embodiments, the terminal device 510 determines the first FDRA based on the at least one FDRA field in the DCI 622, and the terminal device 510 may determine the second FDRA based on the first FDRA or based on a configuration from the network device 520.

In some examples, the terminal device 510 may determine the first FDRA based on the at least one FDRA filed in the DCI 622 and the resource allocation type indicated by the configuration information 612.

### If the Resource Allocation Type is RA Type 0:

The terminal device 510 may determine the first FDRA based on the FDRA filed in the DCI 612, or based on a configuration from the network device 520. Specifically, the terminal device 510 may determine a first set of RBGs with a first number, and then determine the first FDRA based on the first set of RBGs with the first number (may be called as a first RBG size).

For example, the terminal device 510 may determine a first RBG size for the first communication based on the FDRA field, such as the bitmap in the DCI 622. For another example, if the network device 520 has configured a UL/DL wideband RBG size and the first communication is associated with a UL/DL wideband bandwidth, then the terminal device 510 may determine a first RBG size for the first communication based on the configured UL/DL wideband RBG size. For another example, if the network device 520 has configured a UL/DL subband RBG size and the first communication is associated with a UL/DL subband bandwidth, then the terminal device 510 may determine a first RBG size for the first communication based on the configured UL/DL subband RBG size.

The terminal device 510 may determine the second FDRA based on the first FDRA or based on a configuration from the network device 520. Specifically, the terminal device 510 may determine a second set of RBGs with a second number, and then determine the second FDRA based on the second set of RBGs with the second number (may be called as a second RBG size).

In some examples, a second RBG size may be determined based on the first RBG size and an offset. For example, the following equation (3) may be used for determining the second FDRA based on the first FDRA:

$$subband RBG / wideband RBG = offset \qquad ( 3 )$$

In equation (3), the subband RBG and the wideband RBG may be in unit of PRBs. For example, if the first communication is an SBFD communication and the second communication is a non-SBFD communication, then the second FDRA may be determined by subband RBG/offset; if the first communication is a non-SBFD communication and the second communication is an SBFD communication, then the second FDRA may be determined by wideband RBG×offset.

In some examples, the offset may be a ratio of a bandwidth of a subband for the SBFD communication and a bandwidth of a band for the non-SBFD communication, such as, offset=subband bandwidth/wideband bandwidth. In some examples, the offset may be configured by the network device 520, for example, the network device 520 may configure a value for the offset, where the value may be greater than 0 and less than 1.

In some other examples. the network device 520 has configured a UL/DL wideband RBG size and the second communication is associated with a UL/DL wideband bandwidth, then the terminal device 510 may determine the second RBG size for the second communication based on the configured UL/DL wideband RBG size. For another example, if the network device 520 has configured a UL/DL subband RBG size and the second communication is associated with a UL/DL subband bandwidth, then the terminal device 510 may determine the second RBG size for the second communication based on the configured UL/DL subband RBG size.

### If the Resource Allocation Type is RA Type 1:

The terminal device 510 may determine the first FDRA based on the FDRA filed in the DCI 612. Specifically, the terminal device 510 may determine a first index of a first starting resource block and a first length, and then determine the first FDRA based on the first index of the first starting resource block and the first length.

For example, the terminal device 510 may determine the first index of the first starting resource block and the first length based on the FDRA field, such as the RIV in the DCI 622. If the first communication is associated with a UL/DL wideband bandwidth, the first index of the first starting resource block and the first length may be represented by wideband RBₛₜₐᵣₜ and wideband L_{RBS} respectively. If the first communication is associated with a UL/DL subband bandwidth, the first index of the first starting resource block and the first length may be represented by subband RBₛₜₐᵣₜ and subband L_{RBS} respectively.

The terminal device 510 may determine the second FDRA based on the first FDRA. Specifically, the terminal device 510 may determine a second index of a second starting resource block and a second length, and then determine the second FDRA based on the second index of the second starting resource block and the second length.

In some examples, the second index of the second starting resource block may be determined based on the first index and an offset. For example, the following equation (4) may be used:

$$subband {RB}_{start} / wideband {RB}_{start} = offset \qquad ( 4 )$$

For example, if the first communication is an SBFD communication and the second communication is a non-SBFD communication, then the second index of the second starting resource block may be determined by subband RBₛₜₐᵣₜ/offset; if the first communication is a non-SBFD communication and the second communication is an SBFD communication, then the second index of the second starting resource block may be determined by wideband RBₛₜₐᵣₜ×offset.

In some other examples, the second index of the second starting resources block may be determined based on the first index, the offset, and a further offset configured by the network device 520. For example, the following equation (5) may be used:

$$wideband {RB}_{start} \times offset = subband {RB}_{start} + {offset}_{2} \qquad ( 5 )$$

In equation (5), offset₂ refers to the further offset, and it may be a positive value or a negative value. For example, if the first communication is an SBFD communication and the second communication is a non-SBFD communication, then the second index of the second starting resource block may be determined by (subband RBₛₜₐᵣₜ+offset₂)/offset; if the first communication is a non-SBFD communication and the second communication is an SBFD communication, then the second index of the second starting resource block may be determined by wideband RBₛₜₐᵣₜ×offset−offset₂.

It is to be understood that equation (5) is used only for illustration without limitation, for example, the further offset may be represented by offset₃ which may a positive value or a negative value, and equation (6) may be used:

$$wideband {RB}_{start} - {offset}_{3} = subband {RB}_{start} / offset \qquad ( 6 )$$

In some examples, the second length may be determined based on the first length and the offset. For example, the following equation (4) may be used:

$$subband {L}_{RBS} / wideband {L}_{RBS} = offset \qquad ( 7 )$$

For example, if the first communication is an SBFD communication and the second communication is a non-SBFD communication, then the second length may be determined by subband L_{RBS}/offset; if the first communication is a non-SBFD communication and the second communication is an SBFD communication, then the second length may be determined by wideband L_{RBS}×offset.

As such, the terminal device 510 can determine the first FDRA and the second FDRA based on one or more of: the at least one FDRA field in the DCI 622, the resource allocation type, the offset. or the further offset.

In some other example embodiments, if the DCI 622 schedules or configures a single transmission/reception on SBFD slots/mini-slots/symbols, and the FDRA field in the DCI 622 is associated with the subband bandwidth or the wideband bandwidth, the terminal device 510 may determine the FDRA for the single transmission/reception on SBFD slots/mini-slots/symbols in a similar way.

The network device 520 determines 650 the first FDRA and the second FDRA. The determination at 650 is similarly with the determination at 640 and thus will not repeat herein.

The terminal device 510 and the network device 520 perform 660 the first communication and the second communication. Specifically, the terminal device 510 may perform the first communication and the second communication based on the first FDRA and the second FDRA respectively, and the network device 520 performs the first communication and the second communication based on the first FDRA and the second FDRA respectively.

The order of the first communication and the second communication is determined based on the configuration information 612 and the DCI 622. With reference to FIG. 4, and take UL transmission for example, if the at least one FDRA field in the DCI 622 is associated with a bandwidth of the first communication, and the type of the first communication is an SBFD communication, the terminal device 510 may perform the first communication (a first transmission) based on the first FDRA during SBFD slots 434, and then perform the second communication (a second transmission) based on the second FDRA during non-SBFD slots 436. From a perspective of the network device 520, the network device 520 perform the first communication (a first reception) based on the first FDRA during SBFD slots 434, and then perform the second communication (a second reception) based on the second FDRA during non-SBFD slots 436.

With reference to FIG. 4, and take DL transmission for example, if the at least one FDRA field in the DCI 622 is associated with a bandwidth of the first communication, and the type of the first communication is an SBFD communication, the terminal device 510 may perform the second communication (a second reception) based on the second FDRA during non-SBFD slots 432, and then perform the first communication (a first reception) based on the first FDRA during SBFD slots 434. From a perspective of the network device 520, the network device 520 perform the second communication (a second transmission) based on the second FDRA during non-SBFD slots 432, and then perform the first communication (a first transmission) based on the first FDRA during SBFD slots 434.

According to the example embodiments with reference to FIG. 6, when communications are dynamically scheduled or activated by a DCI, the terminal device 510 may determine different FDRAs for SBFD communication and non-SBFD communication. As such, the example embodiments provide a solution for indicating larger physical resource for PUSCH/PDSCH repetitions in non-SBFD slots/mini-slots/symbols compared to PUSCH/PDSCH repetitions in SBFD slots/mini-slots/symbols. Therefore, for the same time domain resource allocation, the PUSCH/PDSCH repetitions in non-SBFD slots/mini-slots/symbols will have larger physical resource, i.e., larger number of resource elements (REs) compared to PUSCH/PDSCH repetitions in SBFD slots/mini-slots/symbols. Thus, larger bandwidth in the non-SBFD slots/mini-slots/symbols can be exploited, the reliability of the PUSCH/PDSCH repetitions can be improved, and the efficiency of communication may be improved.

For example, with larger resource and the same transport block size (TBS), the PUSCH/PDSCH repetitions in non-SBFD slots/mini-slots/symbols can convey more encoded bits (e.g., more than one cycle from the circular buffer), and thus can improve the reliability of the repetitions. For example, for multi-PUSCH scheduling or multi-PDSCH scheduling, larger TBS can be mapped to the transmissions in non-SBFD slots/mini-slots/symbols with larger resource, for the same indicated MCS, the data rate can be improved. Additionally, the DCI size is not increased in the present disclosure, therefore, the overhead issue can be avoided.

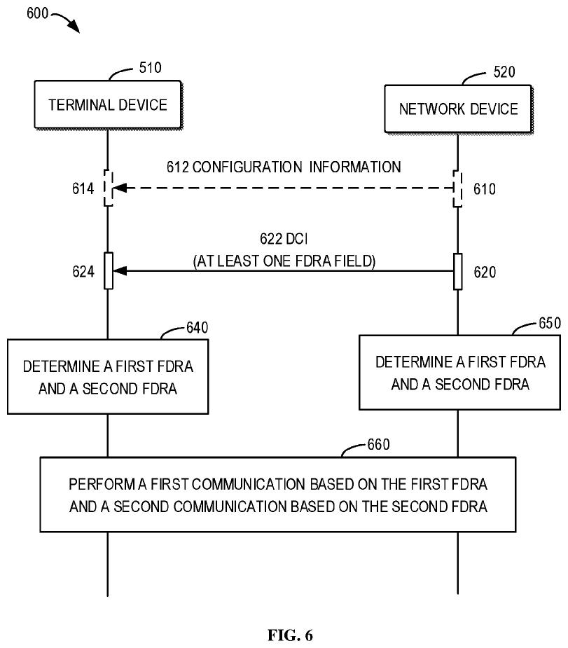

FIG. 7 illustrates a flowchart 700 of a method implemented at a terminal device in accordance with some example embodiments of the present disclosure. For the purpose of discussion, the method 500 will be described from the perspective of the terminal device 510 with reference to FIG. 5.

At block 710, the terminal device 510 receives downlink control information (DCI) from a network device 520, where the DCI comprises at least one frequency-domain resource allocation (FDRA) field for at least one communication to be dynamically scheduled or be activated. At block 720, the terminal device 510 determines a first FDRA on a first bandwidth of a first communication and a second FDRA on a second bandwidth of a second communication, based on the at least one FDRA field in the DCI, where the first communication is one of the SBFD communication or the non-SBFD communication, and the second communication is another one of the SBFD communication or the non-SBFD communication. At block 730, the terminal device 510 performs the first communication and the second communication with the network device 520 based on the first FDRA and the second FDRA, respectively.

In some example embodiments, the terminal device 510 receives configuration information from the network device 520, where the configuration information indicates one or more of: a frequency band, a first number of time units for both uplink and downlink transmissions, a first location of the first number of time units in a radio frame, a second number of time units for uplink transmission, a second location of the second number of time units in the radio frame, a third number of time units for downlink transmission, a third location of the third number of time units in the radio frame, or a resource allocation type.

In some example embodiments, the time units are slots or mini-slots or symbols.

In some example embodiments, the configuration information comprises trigger information, where the trigger information triggers the terminal device 510 to determine different FDRAs for the SBFD communication and the non-SBFD communication.

In some example embodiments, the DCI further comprises trigger information. where the trigger information triggers the terminal device 510 to determine different FDRAs for the SBFD communication and the non-SBFD communication.

In some example embodiments, the terminal device 510 determines the first FDRA based on the at least one FDRA field in the DCI; and the terminal device 510 determines the second FDRA based on the first FDRA and an offset.

In some example embodiments, based on determining that a resource allocation type indicated by configuration information from the network device 520 is type 0, the terminal device 510 determines a first set of resource block groups (RGBs) with a first number based on the at least one FDRA field in the DCI.

In some example embodiments, the terminal device 510 determines a second set of RGBs with a second number based on the first number and the offset.

In some example embodiments, based on determining that the resource allocation type indicated by configuration information from the network device is type 1, the terminal device 510 determines a first index of a first starting resource block and a first length based on the at least one FDRA field in the DCI.

In some example embodiments, the terminal device 510 determines a second index of a second starting resource block based on the first index and the offset; and the terminal device 510 determines a second length based on the first length and the offset.

In some example embodiments, the terminal device 510 determines the second index of the second starting resource block based on the first index, the offset, and a further offset configured by the network device.

In some example embodiments, the offset comprises one or more of: a ratio of a bandwidth of a subband for the SBFD communication and a bandwidth of a band for the non-SBFD communication. or a value configured by the network device 520.

In some example embodiments, based on determining that a resource allocation type indicated by configuration information from the network device is type 0, the terminal device 510 determines a first set of resource block groups (RGBs) with a first number based on the at least one FDRA field in the DCI; and the terminal device 510 determines a second set of RGBs with a second number based on a configuration from the network device.

In some example embodiments, a type of the first communication associated with the at least one FDRA field is predefined or is configured by the network device 520.

In some example embodiments, the SBFD communication is performed on SBFD slots or SBFD mini-slots or SBFD symbols, and the non-SBFD communication is performed on non-SBFD slots or non-SBFD mini-slots or non-SBFD symbols.

In some example embodiments, the first communication and the second communication are transmissions to the network device 520, or the first communication and the second communication are receptions from the network device 520.

In some example embodiments, the first communication and the second communication are physical uplink shared channel (PUSCH) repetitions or physical downlink shared channel (PDSCH) repetitions.

In some example embodiments, the first communication and the second communication are multi-PUSCH scheduling or multi-PDSCH scheduling.

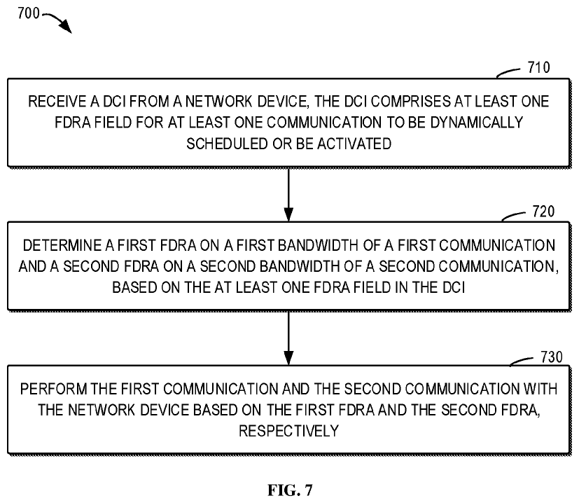

FIG. 8 illustrates a flowchart 800 of a method implemented at a network device in accordance with some example embodiments of the present disclosure. For the purpose of discussion, the method 800 will be described from the perspective of the network device 520 with reference to FIG. 5.

At block 810, the network device 520 transmits downlink control information (DCI) to a terminal device 510, where the DCI comprises at least one frequency domain resource allocation (FDRA) field for at least one communication to be dynamically scheduled or be activated; the at least one FDRA in the DCI is used for determining a first FDRA on a first bandwidth of a first communication and a second FDRA on a second bandwidth of a second communication, where the first communication is one of the SBFD communication or the non-SBFD communication. and the second communication is another one of the SBFD communication or the non-SBFD communication. At block 820, the network device 520 performs the first communication and the second communication with the terminal device based on the first FDRA and the second FDRA, respectively.

In some example embodiments, the network device 520 transmits configuration information to the terminal device 510, where the configuration information indicates one or more of: a frequency band, a first number of time units for both uplink and downlink transmissions, a first location of the first number of time units in a radio frame, a second number of time units for uplink transmission, a second location of the second number of time units in the radio frame, a third number of time units for downlink transmission, a third location of the third number of time units in the radio frame, or a resource allocation type.

In some example embodiments, the time units are slots or mini-slots or symbols.

In some example embodiments, the configuration information comprises trigger information, where the trigger information triggers the terminal device to determine different FDRAs for the SBFD communication and the non-SBFD communication.

In some example embodiments, the DCI further comprises trigger information, where the trigger information triggers the terminal device 510 to determine different FDRAs for the SBFD communication and the non-SBFD communication.

In some example embodiments, the network device 520 determines the first FDRA based on the at least one FDRA field in the DCI; and the network device 520 determines the second FDRA based on the first FDRA and an offset.

In some example embodiments, based on determining that a resource allocation type is type 0, the network device 520 determines a first set of resource block groups (RGBs) with a first number based on the at least one FDRA field in the DCI.

In some example embodiments, the network device 520 determines a second set of RGBs with a second number based on the first number and the offset.

In some example embodiments, based on determining that the resource allocation type is type 1, the network device 520 determines a first index of a first starting resource block and a first length based on the at least one FDRA field in the DCI.

In some example embodiments, the network device 520 determines a second index of a second starting resource block based on the first index and the offset; and the network device 520 determines a second length based on the first length and the offset.

In some example embodiments, the network device 520 determines the second index of the second starting resource block based on the first index, the offset, and a further offset defined at the network device.

In some example embodiments, the offset comprises one or more of: a ratio of a bandwidth of a subband for the SBFD communication and a bandwidth of a band for the non-SBFD communication, or a value defined at the network device.

In some example embodiments, the network device 520 transmits a configuration to the terminal device 510, where the configuration indicates that the second FDRA comprises a second set of RGBs with a second number.

In some example embodiments, the network device 520 transmits an indication to the terminal device 510, where the indication indicates a type of the first communication associated with the at least one FDRA field.

In some example embodiments, the SBFD communication is performed on SBFD slots or SBFD mini-slots or SBFD symbols, and the non-SBFD communication is performed on non-SBFD slots or non-SBFD mini-slots or non-SBFD symbols.

In some example embodiments, the first communication and the second communication are receptions from the terminal device 510, or the first communication and the second communication are transmissions to the terminal device 510.

In some example embodiments, the first communication and the second communication are physical uplink shared channel (PUSCH) repetitions or physical downlink shared channel (PDSCH) repetitions.

In some example embodiments, the first communication and the second communication are multi-PUSCH scheduling or multi-PDSCH scheduling.

In some example embodiments, an apparatus capable of performing the method 700 (for example, the terminal device 510) may comprise means for performing the respective steps of the method 700. The means may be implemented in any suitable form. For example, the means may be implemented in a circuitry or software module.

In some example embodiments, the apparatus comprises: means for receiving, at a terminal device from a network device, where downlink control information (DCI) comprises at least one frequency-domain resource allocation (FDRA) field for at least one communication to be dynamically scheduled or be activated; means for determining a first FDRA on a first bandwidth of a first communication and a second FDRA on a second bandwidth of a second communication based on the at least one FDRA field in the DCI; and means for performing the first communication and the second communication with the network device based on the first FDRA and the second FDRA, respectively, where the first communication is one of the SBFD communication or the non-SBFD communication, and the second communication is another one of the SBFD communication or the non-SBFD communication.

In some example embodiments, the apparatus further comprises: means for receiving configuration information from the network device. where the configuration information indicates at least one of: a frequency band, a first number of time units for both uplink and downlink transmissions, a first location of the first number of time units in a radio frame, a second number of time units for uplink transmission, a second location of the second number of time units in the radio frame. a third number of time units for downlink transmission, a third location of the third number of time units in the radio frame, or a resource allocation type.

In some example embodiments, the time units are slots or mini-slots or symbols.

In some example embodiments, the configuration information comprises trigger information, where the trigger information triggers the terminal device to determine different FDRAs for the SBFD communication and the non-SBFD communication.

In some example embodiments, the DCI further comprises trigger information, where the trigger information triggers the terminal device to determine different FDRAs for the SBFD communication and the non-SBFD communication.

In some example embodiments, the means for determining the first FDRA and the second FDRA comprises: means for determining the first FDRA based on the at least one FDRA field in the DCI; and means for determining the second FDRA based on the first FDRA and an offset.

In some example embodiments, the means for determining the first FDRA comprises: means for in accordance with a determination that a resource allocation type indicated by configuration information from the network device is type 0, determining a first set of resource block groups (RGBs) with a first number based on the at least one FDRA field in the DCI.

In some example embodiments, the means for determining the second FDRA comprises: means for determining a second set of RGBs with a second number based on the first number and the offset.

In some example embodiments, the means for determining the first FDRA comprises: means for in accordance with a determination that the resource allocation type indicated by configuration information from the network device is type 1, determining a first index of a first starting resource block and a first length based on the at least one FDRA field in the DCI.

In some example embodiments, the means for determining the second FDRA comprises: means for determining a second index of a second starting resource block based on the first index and the offset; and means for determining a second length based on the first length and the offset.

In some example embodiments, the means for determining the second index comprises: means for determining the second index of the second starting resource block based on the first index, the offset, and a further offset configured by the network device.

In some example embodiments, the offset comprises at least one of: a ratio of a bandwidth of a subband for the SBFD communication and a bandwidth of a band for the non-SBFD communication. or a value configured by the network device.

In some example embodiments, the means for determining the first FDRA and the second FDRA comprises: means for in accordance with a determination that a resource allocation type indicated by configuration information from the network device is type 0, determining a first set of resource block groups (RGBs) with a first number based on the at least one FDRA field in the DCI; and means for determining a second set of RGBs with a second number based on a configuration from the network device.

In some example embodiments, a type of the first communication associated with the at least one FDRA field is predefined or is configured by the network device.

In some example embodiments, the SBFD communication is performed on SBFD slots or SBFD mini-slots or SBFD symbols. and the non-SBFD communication is performed on non-SBFD slots or non-SBFD mini-slots or non-SBFD symbols.

In some example embodiments, the first communication and the second communication are transmissions to the network device, or the first communication and the second communication are receptions from the network device.

In some example embodiments, the first communication and the second communication are physical uplink shared channel (PUSCH) repetitions or physical downlink shared channel (PDSCH) repetitions.

In some example embodiments, the first communication and the second communication arc multi-PUSCH scheduling or multi-PDSCH scheduling.

In some example embodiments, an apparatus capable of performing the method 800 (for example, the network device 520) may comprise means for performing the respective steps of the method 800. The means may be implemented in any suitable form. For example, the means may be implemented in a circuitry or software module.

In some example embodiments, the apparatus comprises: means for transmitting, at a network device to a terminal device, downlink control information (DCI) comprising at least one frequency domain resource allocation (FDRA) field for at least one communication to be dynamically scheduled or be activated, where the at least one FDRA in the DCI is used for determining a first FDRA on a first bandwidth of a first communication and a second FDRA on a second bandwidth of a second communication; and means for performing the first communication and the second communication with the terminal device based on the first FDRA and the second FDRA, respectively, where the first communication is one of the SBFD communication or the non-SBFD communication, and the second communication is another one of the SBFD communication or the non-SBFD communication.

In some example embodiments, the apparatus further comprises: means for transmitting configuration information to the terminal device, where the configuration information indicates at least one of: a frequency band, a first number of time units for both uplink and downlink transmissions, a first location of the first number of time units in a radio frame, a second number of time units for uplink transmission, a second location of the second number of time units in the radio frame, a third number of time units for downlink transmission, a third location of the third number of time units in the radio frame, or a resource allocation type.

In some example embodiments, the time units are slots or mini-slots or symbols.

In some example embodiments, the configuration information comprises trigger information, where the trigger information triggers the terminal device to determine different FDRAs for the SBFD communication and the non-SBFD communication.

In some example embodiments, the DCI further comprises trigger information, where the trigger information triggers the terminal device to determine different FDRAs for the SBFD communication and the non-SBFD communication.

In some example embodiments, the apparatus further comprises: means for determining the first FDRA based on the at least one FDRA field in the DCI; and means for determining the second FDRA based on the first FDRA and an offset.

In some example embodiments, the means for determining the first FDRA comprises: means for in accordance with a determination that a resource allocation type is type 0, determining a first set of resource block groups (RGBs) with a first number based on the at least one FDRA field in the DCI.

In some example embodiments, the means for determining the second FDRA comprises: means for determining a second set of RGBs with a second number based on the first number and the offset.

In some example embodiments, the means for determining the first FDRA comprises: means for in accordance with a determination that the resource allocation type is type 1, determining a first index of a first starting resource block and a first length based on the at least one FDRA field in the DCI.

In some example embodiments, the means for determining the second FDRA comprises: means for determining a second index of a second starting resource block based on the first index and the offset; and means for determining a second length based on the first length and the offset.

In some example embodiments, the means for determining the second index comprises: means for determining the second index of the second starting resource block based on the first index, the offset, and a further offset defined at the network device.

In some example embodiments, the offset comprises at least one of: a ratio of a bandwidth of a subband for the SBFD communication and a bandwidth of a band for the non-SBFD communication, or a value defined at the network device.

In some example embodiments, the apparatus further comprises: means for transmitting a configuration to the terminal device, where the configuration indicates that the second FDRA comprises a second set of RGBs with a second number.

In some example embodiments, the apparatus further comprises: means for transmitting an indication to the terminal device, where the indication indicates a type of the first communication associated with the at least one FDRA field.

In some example embodiments, the SBFD communication is performed on SBFD slots or SBFD mini-slots or SBFD symbols, and the non-SBFD communication is performed on non-SBFD slots or non-SBFD mini-slots or non-SBFD symbols.

In some example embodiments, the first communication and the second communication are receptions from the terminal device, or the first communication and the second communication are transmissions to the terminal device.

In some example embodiments, the first communication and the second communication are physical uplink shared channel (PUSCH) repetitions or physical downlink shared channel (PDSCH) repetitions.

In some example embodiments, the first communication and the second communication are multi-PUSCH scheduling or multi-PDSCH scheduling.

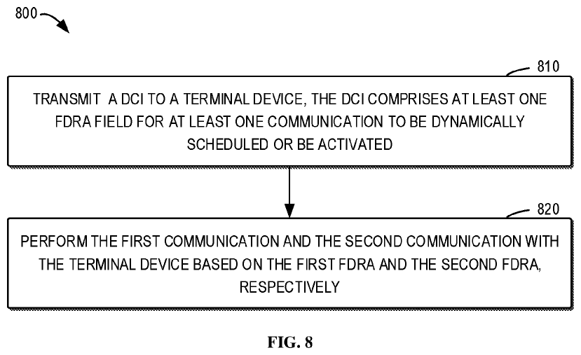

FIG. 9 illustrates a simplified block diagram of a device 900 that is suitable for implementing some example embodiments of the present disclosure. The device 900 may be provided to implement the communication device, for example the terminal device 510, or the network device 520 as shown in FIG. 5. As shown, the device 900 includes one or more processors 910, one or more memories 920 coupled to the processor 910, and one or more communication modules 940 coupled to the processor 910.

The communication module 940 is for bidirectional communications. The communication module 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 924. The processor 910 may perform any suitable actions and processing by loading the program 930 into the RAM 922.

The embodiments of the present disclosure may be implemented by means of the program 930 so that the device 900 may perform any process of the disclosure as discussed with reference to FIGS. 6-8. The embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like.

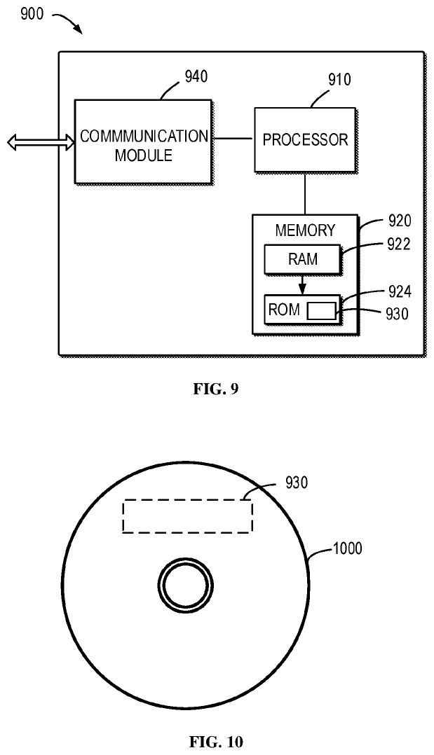

FIG. 10 illustrates a block diagram of an example of a computer readable medium 1000 in accordance with some example embodiments of the present disclosure. The computer readable medium 1000 has the program 930 stored thereon. It is noted that although the computer readable medium 1000 is depicted in form of CD or DVD in FIG. 10, the computer readable medium 1000 may be in any other form suitable for carry or hold the program 930.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 7-8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
receive downlink control information (DCI) from a network device, the DCI comprising at least one frequency-domain resource allocation (FDRA) field for at least one communication to be dynamically scheduled or be activated;
determine a first FDRA on a first bandwidth of a first communication and a second FDRA on a second bandwidth of a second communication, based on the at least one FDRA field in the DCI; and
perform the first communication and the second communication with the network device based on the first FDRA and the second FDRA, respectively,
wherein the first communication is one of the SBFD communication or the non-SBFD communication, and the second communication is another one of the SBFD communication or the non-SBFD communication.

2. The terminal device of claim 1, wherein the at least one memory storing instructions that, when executed by the at least one processor, cause the terminal device at least to:
receive configuration information from the network device, the configuration information indicating at least one of:
a frequency band,
a first number of time units for both uplink and downlink transmissions,
a first location of the first number of time units in a radio frame,
a second number of time units for uplink transmission,
a second location of the second number of time units in the radio frame,
a third number of time units for downlink transmission,
a third location of the third number of time units in the radio frame, or
a resource allocation type.

3. (canceled)

4. The terminal device of claim 2, wherein the configuration information comprises trigger information, wherein the trigger information triggers the terminal device to determine different FDRAs for the SBFD communication and the non-SBFD communication.

5. The terminal device of claim 1, wherein the DCI further comprises trigger information, wherein the trigger information triggers the terminal device to determine different FDRAs for the SBFD communication and the non-SBFD communication.

6. The terminal device of claim 1, wherein the at least one memory storing instructions that, when executed by the at least one processor, cause the terminal device at least to determine the first FDRA and the second FDRA by:
determining the first FDRA based on the at least one FDRA field in the DCI; and
determining the second FDRA based on the first FDRA and an offset.

7. The terminal device of claim 6, wherein, in accordance with a determination that a resource allocation type indicated by configuration information from the network device is type 0, the at least one memory storing instructions that, when executed by the at least one processor, cause the terminal device at least to determine the first FDRA by:
determining a first set of resource block groups (RGBs) with a first number based on the at least one FDRA field in the DCI; and
cause the terminal device at least to determine the second FDRA by:
determining a second set of RGBs with a second number based on the first number and the offset.

8. (canceled)

9. The terminal device of claim 6, wherein, in accordance with a determination that the resource allocation type indicated by configuration information from the network device is type 1, the at least one memory storing instructions that, when executed by the at least one processor, cause the terminal device at least to determine the first FDRA by:
determining a first index of a first starting resource block and a first length based on the at least one FDRA field in the DCI; and
cause the terminal device at least to determine the second FDRA by:
determining a second index of a second starting resource block based on the first index and the offset and
by determining a second length based on the first length and the offset.

10. (canceled)

11. The terminal device of claim 9, wherein the at least one memory storing instructions that, when executed by the at least one processor, cause the terminal device at least to determine the second index by:
determining the second index of the second starting resource block based on the first index, the offset, and a further offset configured by the network device.

12. The terminal device of claim 6, wherein the offset comprises at least one of:
a ratio of a bandwidth of a subband for the SBFD communication and a bandwidth of a band for the non-SBFD communication, or
a value configured by the network device.

13-14. (canceled)

15. The terminal device of claim 1, wherein the SBFD communication is performed on SBFD slots or SBFD mini-slots or SBFD symbols, and the non-SBFD communication is performed on non-SBFD slots or non-SBFD mini-slots or non-SBFD symbols.

16-18. (canceled)

19. A network device comprising:
at least one processor; and
at least one memory storing instructions that, when executed by the at least one processor, cause the network device at least to:
transmit downlink control information (DCI) to a terminal device, the DCI comprising at least one frequency domain resource allocation (FDRA) field for at least one communication to be dynamically scheduled or be activated, the at least one FDRA in the DCI being for determining a first FDRA on a first bandwidth of a first communication and a second FDRA on a second bandwidth of a second communication; and
perform the first communication and the second communication with the terminal device based on the first FDRA and the second FDRA, respectively,
wherein the first communication is one of the SBFD communication or the non-SBFD communication, and the second communication is another one of the SBFD communication or the non-SBFD communication.

20. The network device of claim 19, wherein the at least one memory storing instructions that, when executed by the at least one processor, cause the network device at least to:
transmit configuration information to the terminal device, the configuration information indicating at least one of:
a frequency band,
a first number of time units for both uplink and downlink transmissions,
a first location of the first number of time units in a radio frame,
a second number of time units for uplink transmission,
a second location of the second number of time units in the radio frame,
a third number of time units for downlink transmission,
a third location of the third number of time units in the radio frame, or
a resource allocation type.

21. (canceled)

22. The network device of claim 20, wherein the configuration information comprises trigger information, wherein the trigger information triggers the terminal device to determine different FDRAs for the SBFD communication and the non-SBFD communication.

23. The network device of claim 19, wherein the DCI further comprises trigger information, wherein the trigger information triggers the terminal device to determine different FDRAs for the SBFD communication and the non-SBFD communication.

24. The network device of claim 19, wherein the at least one memory storing instructions that, when executed by the at least one processor, cause the network device at least to:
determine the first FDRA based on the at least one FDRA field in the DCI; and
determine the second FDRA based on the first FDRA and an offset.

25. The network device of claim 24, wherein, in accordance with a determination that a resource allocation type is type 0, the at least one memory storing instructions that, when executed by the at least one processor, cause the network device at least to determine the first FDRA by:
determining a first set of resource block groups (RGBs) with a first number based on the at least one FDRA field in the DCI; and
cause the network device at least to determine the second FDRA by:
determining a second set of RGBs with a second number based on the first number and the offset.

26. (canceled)

27. The network device of claim 24, wherein, in accordance with a determination that the resource allocation type is type 1, the at least one memory storing instructions that, when executed by the at least one processor, cause the network device at least to determine the first FDRA by:
determining a first index of a first starting resource block and a first length based on the at least one FDRA field in the DCI; and
cause the network device at least to determine the second FDRA by:
determining a second index of a second starting resource block based on the first index and the offset and
by determining a second length based on the first length and the offset.

28. (canceled)

29. The network device of claim 27, wherein the at least one memory storing instructions that, when executed by the at least one processor, cause the network device at least to determine the second index by:
determining the second index of the second starting resource block based on the first index, the offset, and a further offset defined at the network device.

30. (canceled)

31. The network device of claim 19, wherein the at least one memory storing instructions that, when executed by the at least one processor, cause the network device at least to:
transmit a configuration to the terminal device, the configuration indicating that the second FDRA comprises a second set of RGBs with a second number.

32. The network device of claim 19, wherein the at least one memory storing instructions that, when executed by the at least one processor, cause the network device at least to:
transmit an indication to the terminal device, wherein the indication indicates a type of the first communication associated with the at least one FDRA field.

33-41. (canceled)
